(19) United States
(12) Patent Application Publication
(10) Pub. No.: US 2025/0252386 A1
(43) Pub. Date: Aug. 7, 2025

(54) INTERMODAL INVENTORY VISUALIZATION SYSTEMS AND METHODS

(71) Applicant: BNSF Railway Company, Fort Worth, TX (US)

(72) Inventors: Michael I. Ibanez, McAllen, TX (US); Bowen T. Kruse, Helena, MT (US)

(73) Assignee: BNSF Railway Company, Fort Worth, TX (US)

(21) Appl. No.: 18/435,831

(22) Filed: Feb. 7, 2024

Related U.S. Application Data
(63) Continuation-in-part of application No. 18/435,667, filed on Feb. 7, 2024.

(51) Int. Cl. G06Q 10/067; G06Q 10/087; G06V 20/62

(52) U.S. Cl. CPC G06Q 10/067; G06Q 10/087; G06V 20/63; G06V 2201/10

(57) ABSTRACT

According to some embodiments, a method for visualizing inventory of an intermodal container yard includes accessing a unit inventory stored in an inventory database. The unit inventory includes information about a plurality of shipping containers physically located in the intermodal container yard. The method further includes providing one or more instructions to display, on an electronic display of a user computing system, a graphical user interface comprising a three-dimensional representation of the intermodal container yard. The method further includes updating, in real time, the three-dimensional representation of the intermodal container yard based on the information about the plurality of shipping containers in the unit inventory. The method further includes providing one or more instructions to display in the graphical user interface, in response to a user selection of a particular visual representation of a particular shipping container, metadata about the particular shipping container.

### CROSS-REFERENCE TO RELATED APPLICATIONS

The present application is a continuation-in-part of pending U.S. patent application Ser. No. 18/435,667, filed Feb. 7, 2024, the entirety of which is herein incorporated by reference for all purposes.

### TECHNICAL FIELD

This disclosure generally relates to intermodal logistics, and more specifically to intermodal inventory visualization systems and methods.

### BACKGROUND

An intermodal container yard can be a facility in which shipping containers are transferred between trucks and trains. Most intermodal container yards include large storage areas where shipping containers are stored. For example, a truck may enter an intermodal container yard and be instructed to park a shipping container in a designated parking spot. For various reasons, however, a truck driver may not park a shipping container in the requested parking location. As a result, a “yard check” may be utilized by the intermodal container yard to ensure that shipping containers can be located when needed for loading on a train. Yard checks are typically performed by workers that visually observe the units within a yard (e.g., trailers, containers, etc.) and their locations (e.g., lot/row/spots) and manually enter the observed information in an inventory database. Manual yard checks, however, are time consuming, monotonous, and prone to frequent errors.

### SUMMARY

The present disclosure achieves technical advantages as systems, methods, and computer-readable storage media that provide functionality for imaging, identifying, and visualizing inventory such as shipping containers of a rail yard. The present disclosure provides for a system integrated into a practical application with meaningful limitations that may include accessing a unit inventory stored in an inventory database, the unit inventory comprising information about a plurality of shipping containers physically located in the intermodal container yard, and providing one or more instructions to display, on an electronic display of a user computing system, a graphical user interface comprising a three-dimensional representation of the intermodal container yard. Other meaningful limitations of the system integrated into a practical application include: updating the three-dimensional representation of the intermodal container yard based on the information about the plurality of shipping containers in the unit inventory, and providing one or more instructions to display in the graphical user interface, in response to a user selection of a particular visual representation of a particular shipping container, metadata about the particular shipping container.

The present disclosure solves the technological problem of a lack of technical functionality for rail yard checks in current systems by providing methods and system that automatically determine the identifications and locations of shipping containers within a rail yard and then providing a real-time, three-dimensional graphical representation of the rail yard and its inventory. The technological solutions provided herein, and missing from conventional systems, are more than a mere application of a manual process to a computerized environment, but rather include functionality to implement a technical process to supplement current manual solutions for performing yard checks and to augment current inventory systems by providing a mechanism for automatically determining the identifications and locations of shipping containers within a rail yard and then providing a real-time, three-dimensional graphical representation of the rail yard and its inventory. In doing so, the present disclosure goes well beyond a mere application the manual process to a computer.

Unlike existing solutions where personnel may be required to manually traverse a rail yard and manually enter identifications and locations of shipping containers parked in the rail yard, embodiments of this disclosure provide systems and methods that automatically determine the identifications and locations of shipping containers within a rail yard (e.g., using aerial or ground-based vehicles). By providing automatic determination and validation of shipping container inventory and locations, a facility such as a rail yard may be more efficiently and effectively monitored. This may increase the efficiency of the facility and reduce or eliminate the requirement for personnel to manually perform yard checks. This may reduce resource usage (e.g., fuel and electricity) that would otherwise be required by manual yard checks. Furthermore, by providing systems that only transmit data in response to certain events (e.g., the detection of a shipping container in an image), network bandwidth and computer resources (e.g., computer memory and processing power) may be optimized or reduced over existing systems. Still further, by providing a real-time, three-dimensional graphical representation of an intermodal container yard and its inventory (e.g., shipping containers), personnel may have a more accurate understanding of the inventory within the yard, thereby increasing efficiency of the facility. Other technical advantages will be readily apparent to one skilled in the art from the following figures, descriptions, and claims. Moreover, while specific advantages have been enumerated above, various embodiments may include all, some, or none of the enumerated advantages.

Accordingly, the present disclosure discloses concepts inextricably tied to computer technology such that the present disclosure provides the technological benefit of implementing functionality to automatically manage and visualize inventory such as intermodal inventory of a rail yard. The systems and techniques of embodiments provide improved systems by providing capabilities to perform functions that are currently performed manually and to perform functions that are currently not possible.

It is an object of the disclosure to provide systems for automatically managing and visualizing inventory of physical objects such as shipping containers in a rail yard. It is a further object of the disclosure to provide methods of automatically managing and visualizing inventory of physical objects such as shipping containers in a rail yard. These and other objects are provided by the present disclosure, including at least the following embodiments.

In one particular embodiment, a system includes an inventory database storing a unit inventory, one or more memory units, and one or more computer processors communicatively coupled to the inventory database and the one or more memory units. The unit inventory includes information about a plurality of shipping containers physically located in an intermodal container yard. The one or more computer processors are configured to access the unit inventory stored in the inventory database and provide one or more instructions to display, on an electronic display of a user computing system, a graphical user interface that includes a three-dimensional representation of the intermodal container yard. The one or more computer processors are further configured to update, in real time, the three-dimensional representation of the intermodal container yard based on the information about the plurality of shipping containers in the unit inventory. Updating the three-dimensional representation of the intermodal container yard includes providing, in the three-dimensional representation of the intermodal container yard, a visual representation of each shipping container physically located in the intermodal container yard, wherein the visual representation of each particular shipping container is placed at a virtual parking location in the three-dimensional representation of the intermodal container yard that corresponds to a physical parking location of the particular shipping container in the intermodal container yard. Updating the three-dimensional representation of the intermodal container yard further includes providing, in the three-dimensional representation of the intermodal container yard, a visual representation of a current location of a vehicle travelling within the intermodal container yard. The one or more computer processors are further configured to provide one or more instructions to display in the graphical user interface, in response to a user selection of a particular visual representation of a particular shipping container, metadata about the particular shipping container.

In another embodiment, a method for visualizing inventory of an intermodal container yard includes accessing a unit inventory stored in an inventory database and providing one or more instructions to display, on an electronic display of a user computing system, a graphical user interface that includes a three-dimensional representation of the intermodal container yard. The method further includes updating the three-dimensional representation of the intermodal container yard based on the information about the plurality of shipping containers in the unit inventory. Updating the three-dimensional representation of the intermodal container yard includes providing, in the three-dimensional representation of the intermodal container yard, a visual representation of each shipping container physically located in the intermodal container yard, wherein the visual representation of each particular shipping container is placed at a virtual parking location in the three-dimensional representation of the intermodal container yard that corresponds to a physical parking location of the particular shipping container in the intermodal container yard. Updating the three-dimensional representation of the intermodal container yard further includes providing, in the three-dimensional representation of the intermodal container yard, a visual representation of a current location of a vehicle travelling within the intermodal container yard. The method further includes providing one or more instructions to display in the graphical user interface, in response to a user selection of a particular visual representation of a particular shipping container, metadata about the particular shipping container.

In another embodiment, one or more computer-readable non-transitory storage media embodies instructions that, when executed by a processor, cause the processor to perform operations including accessing a unit inventory stored in an inventory database and providing one or more instructions to display, on an electronic display of a user computing system, a graphical user interface that includes a three-dimensional representation of the intermodal container yard. The instructions further include updating the three-dimensional representation of the intermodal container yard based on the information about the plurality of shipping containers in the unit inventory. Updating the three-dimensional representation of the intermodal container yard includes providing, in the three-dimensional representation of the intermodal container yard, a visual representation of each shipping container physically located in the intermodal container yard, wherein the visual representation of each particular shipping container is placed at a virtual parking location in the three-dimensional representation of the intermodal container yard that corresponds to a physical parking location of the particular shipping container in the intermodal container yard. Updating the three-dimensional representation of the intermodal container yard further includes providing, in the three-dimensional representation of the intermodal container yard, a visual representation of a current location of a vehicle travelling within the intermodal container yard. The instructions further include providing one or more instructions to display in the graphical user interface, in response to a user selection of a particular visual representation of a particular shipping container, metadata about the particular shipping container.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a diagram illustrating an overhead view of a container yard, according to particular embodiments.

FIG. 2 is a diagram illustrating an intermodal inventory management system for managing the inventory of the container yard of FIG. 1, according to particular embodiments.

FIG. 3 is a diagram illustrating an inventory imaging system determining a parking location of a shipping container, according to particular embodiments.

FIG. 4 is a flow diagram illustrating an example method for managing intermodal inventory, according to particular embodiments.

FIGS. 5A-5D illustrate a virtual container yard that may be displayed in a graphical user interface on a user computing system in order to visualize the physical inventory of a physical container yard, according to certain embodiments, according to particular embodiments.

FIG. 6 is a flow diagram illustrating an example method for providing the virtual container yard of FIGS. 5A-5D in order to visualize intermodal inventory, according to particular embodiments.

FIG. 7 is an example computer system that can be utilized to implement aspects of the various technologies presented herein, according to particular embodiments.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

An intermodal container yard can be a facility in which shipping containers are transferred between trucks and trains. Most intermodal container yards include vast storage areas where shipping containers are stored. For example, a truck may enter an intermodal container yard and be instructed to park a shipping container in a designated parking spot. For various reasons, however, a truck driver may not park a shipping container in the requested parking location. As a result, a “yard check” may be utilized by the intermodal container yard to ensure that shipping containers can be located when needed for loading on a train. Yard checks are typically performed by workers that visually observe the units within a yard (e.g., trailers, containers, etc.) and their locations (e.g., lot/row/spots) and manually enter the observed information in an inventory database. Manual yard checks, however, are time consuming, monotonous, and prone to frequent errors.

To address these and other problems with managing inventory such as shipping containers stored in intermodal container yards, the disclosed embodiments provide systems and methods for imaging and identifying intermodal inventory. In some embodiments, the disclosed systems and methods utilize one or more inventory imaging systems that may be moved around within a container yard to ingest information about the container yard. For example, an inventory imaging system may be attached to a container delivery vehicle (e.g., a railroad hostler vehicle) and may capture information about a subset of the containers in the container yard as the container delivery vehicle moves containers between trains and parking spots within the container yard. As another example, an inventory imaging system may be attached to a dedicated imaging vehicle (e.g., an aerial vehicle such as a drone, an automobile, a truck, a golf cart, an all-terrain vehicle (ATV), an autonomous vehicle, a motorcycle, a remote-control vehicle, and the like) and may capture information about the complete inventory of containers in the container yard as the dedicated imaging vehicle traverses a dedicated route through the entire container yard. The inventory imaging systems may include a computing system and an imaging device (e.g., a camera). The inventory imaging systems may be configured to utilize an onboard machine-learning module to continuously analyze images captured by the imaging device and identify containers in the images. Once a container has been identified, the inventory imaging system may send a message to a remote computing system about the identified container (e.g., parking location, unit identification markings, etc.) By automatically performing image analysis (e.g., machine learning inference) in real time by the inventory imaging system directly on the imaging vehicle, shipping containers and their associated information (e.g., parking locations and identification markings) may be updated in inventory much quicker (e.g., in real-time or near real-time) than other systems that rely on back-end servers for image processing. Furthermore, some embodiments of the disclosed inventory imaging systems conserve network bandwidth by only electronically transmitting information when an event of interest occurs (e.g., in response to identifying a container within captured images). These and other features and advantages of the disclosed embodiments are discussed in more detail below.

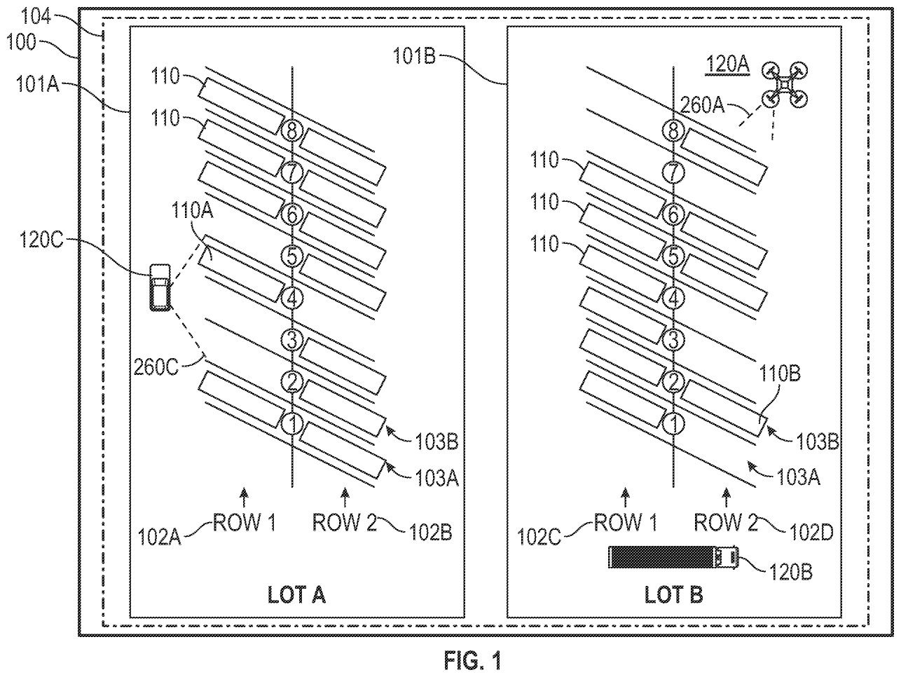

FIG. 1 is a diagram illustrating an overhead view of a container yard 100, according to particular embodiments. In general, container yard 100 can be an area within an intermodal rail yard for storing shipping containers 110. Shipping containers 110 may be parked in a specific location (e.g., parking location 300) that can be identified by a lot 101, a row 102, and a spot 103. For example, shipping container 110A can be parked in lot 101A (“A”), row 102A (“1”), and spot 103A (“1”). As another example, shipping container 110B can be parked in lot 101B (“B”), row 102D (“2”), and spot 103B (“2”). Shipping containers 110 may be any appropriate containers that may be transported and parked within container yard 100. In some embodiments, shipping containers 110 are intermodal shipping containers that are able to be transported by both rail and truck.

In addition to shipping containers 110, container yard 100 includes one or more imaging vehicles 120. In general, imaging vehicles 120 have attached imaging systems (e.g., inventory imaging system 220) that capture and analyze images of container yard 100 and transmit messages 125 about shipping containers 110 to a remote computing system. In the illustrated embodiments, imaging vehicles 120 include an imaging vehicle 120A, an imaging vehicle 120B, and an imaging vehicle 120C. Imaging vehicle 120A can be an aerial vehicle (e.g., a drone, a remote-control (RC) airplane, etc.) with one or more attached inventory imaging systems. Imaging vehicle 120B can be a container delivery vehicle (e.g., a hostler vehicle, a tractor, a truck, etc.) with one or more attached inventory imaging systems. Imaging vehicle 120C can be any other ground vehicle (e.g., an automobile, a utility vehicle, an RC vehicle, etc.) with one or more attached inventory imaging systems.

In general, the inventory imaging systems that are attached to imaging vehicles 120 are systems and devices that capture and analyze images of container yard 100 in order to identify shipping containers 110 and their locations within container yard 100. In some embodiments, imaging vehicles 120 (e.g., imaging vehicles 120A-120C) move about container yard 100 and capture images or videos of shipping containers 110. The inventory imaging systems then process the captured images or videos in real-time using machine learning model inferencing in order identify shipping containers 110 within the captured images or videos. Once a shipping container 110 is identified, the inventory imaging systems may additionally determine one or more unit identifications and a parking location of the identified shipping container 110. The determined unit identifications and the parking location of the shipping container 110 are then electronically communicated to a remote computer system and used for updating a database of the inventory of container yard 100. More details about the inventory imaging systems that may be attached to imaging vehicles 120 are discussed in more detail below.

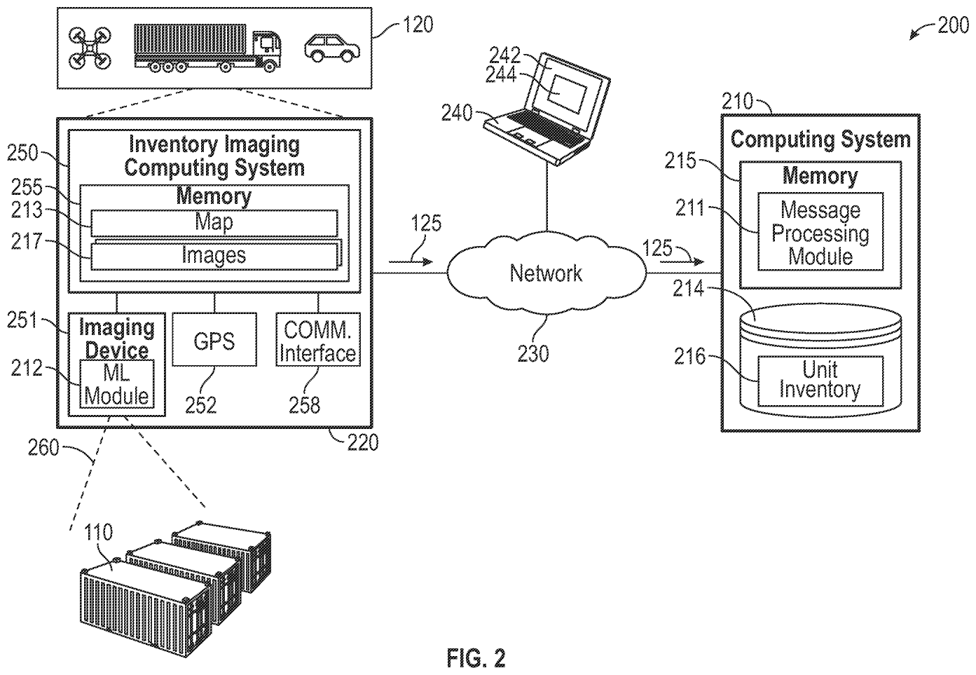

FIG. 2 is a diagram illustrating an intermodal inventory management system 200 for imaging and identifying the inventory of container yard 100, according to particular embodiments. Intermodal inventory management system 200 includes a remote computing system 210, one or more inventory imaging systems 220, and a user computing system 240, all of which are communicatively coupled via a network 230. Remote computing system 210 includes memory 215 and inventory database 214. Memory 215 stores message processing module 211 and inventory database 214 stores unit inventory 216. Inventory imaging computing system 250 is attached to an imaging vehicle 120 and includes memory 255, imaging device 251 that stores a machine learning module 212, GPS module 252, and communications interface 258. Memory 255 stores a map 213 and images 217.

In general, inventory imaging system 220 captures and analyzes images 217 as imaging vehicle 120 moves within container yard 100 in order to determine parking locations of shipping containers 110. To do so, inventory imaging system 220 may first analyze images 217 captured by imaging device 251 using machine learning module 212 in order to determine that a shipping container 110 is depicted in at least one image 217. Inventory imaging system 220 may then determine, using map 213 of the container yard 100, a parking location of the shipping container 110 identified in images 217. In response to determining that the shipping container 110 is depicted within at least one image 217, inventory imaging system 220 may electronically communicate to remote computing system 210 (e.g., across network 230 using communications interface 258) a message 125 about the identified shipping container 110. The message 125 sent to remote computing system 210 may include data such as the determined parking location of the identified shipping container 110 and one or more identification markings of the identified shipping container 110. In order to conserve network bandwidth, some embodiments of inventory imaging system 220 send message 125 only if machine learning module 212 identifies shipping container 110 within images 217. Once message 125 is received by remote computing system 210, message processing module 211 updates unit inventory 216 using the data within message 125. More details about the operation of inventory imaging system 220 are discussed below.

Messages 125 can be information provided by inventory imaging system 220 to intermodal inventory management system 200. In general, each message 125 provides data/information about a shipping container 110 within container yard 100. In some embodiments, message 125 includes a unit identification number of a particular shipping container 110 and a parking location of the particular shipping container 110 within container yard 100. For example, when inventory imaging system 220 determines that shipping container 110A has a unit identification number of “BICU 123456” and is parked in lot/row/spot location of A-1-1 as illustrated in FIG. 1, inventory imaging system 220 may send a message 125 to intermodal inventory management system 200 that includes the unit identification number of “BICU 123456” and lot/row/spot location of A-1-1. As another example, when inventory imaging system 220 determines that shipping container 110B has a unit identification number of “BICU 654321” and is parked in lot/row/spot location of B-2-2 as illustrated in FIG. 1, yard check source 120B may send a message 125 to intermodal inventory management system 200 that includes the unit identification number of “BICU 654321” and lot/row/spot location of B-2-2.

Message 125 can include any format, including JavaScript Object Notation (JSON), TCP/IP, XML, HTML, ASCII, SMS, CSV, API, or other suitable format. Each message 125 can consist of a message header, header properties, and a message body, or be encapsulated and packetized by any suitable format. In some embodiments, messages 125 are sent via a distributed event streaming platform such as APACHE KAFKA.

In some embodiments, intermodal inventory management system 200 includes a message processing module 211. In general, message processing module 211 processes messages 125 received from inventory imaging system 220 and stores the data within messages 125 about shipping containers 110 in unit inventory 216. Message processing module 211 represents any suitable set of instructions, logic, or code embodied in a computer-readable storage medium. For example, message processing module 211 may be embodied in memory 215, a disk, a CD, or a flash drive. In particular embodiments, message processing module 211 may include instructions (e.g., a software application) executable by processor to perform one or more of the functions described herein.

Machine learning module 212 can be any hardware, software, or combination of hardware and software that is capable of analyzing images 217 in order to identify shipping containers 110 within images 217 in real-time or near real-time. In some embodiments, machine learning module 212 includes one or more neural networks that have been trained to perform object detection, inference, and recognition on images 217 in order to identify shipping containers 110.

Map 213 is stored information about the physical properties of container yard 100. In some embodiments, map 213 includes information about the parking locations of container yard 100. For example, map 213 may include GPS coordinates of each parking location. As a specific example, map 213 may include GPS coordinates of the four corners of a rectangle that overlays each parking location within container yard 100 (e.g., lot/row/spot location of A-1-1 as illustrated in FIG. 1). In some embodiments, map 213 is a geographic information system (GIS) map.

Inventory database 214 of remote computing system 210 may store certain types of information for remote computing system 210 and message processing module 211. Inventory database 214 may be any one or a combination of volatile or non-volatile local or remote devices suitable for storing information. Inventory database 214 may include RAM, ROM, magnetic storage devices, optical storage devices, or any other suitable information storage device or a combination of these devices. Inventory database 214 may be a component external or internal to remote computing system 210. Inventory database 214 may be located in any location suitable for inventory database 214 to store information for remote computing system 210. For example, inventory database 214 may be located in a cloud environment. In general, inventory database 214 stores unit inventory 216, which includes data from messages 125 (e.g., parking locations of shipping containers 110 and unit identifications of shipping containers 110).

Images 217 are captured by imaging device 251 and may be stored in memory 255. Images 217 may be still images or may be videos. Images 217 may be in an appropriate data format and may be of any appropriate resolution and size.

Imaging device 251 is any appropriate system or device to capture images 217 of shipping containers 110 within container yard 100. In some embodiments, imaging device 251 is a high-resolution camera from LUXONIS that includes built-in functionality for machine learning (e.g., via machine learning module 212) and depth vision. In some embodiments, imaging device 251 includes a field of view 260 that may be directed at a known direction away from imaging vehicle 120 such that it captures shipping containers 110 as imaging vehicle 120 moves along rows 102 of container yard 100.

GPS module 252 can be any appropriate system, device, or application to communicate with one or more satellites to determine Global Positioning System (GPS) coordinates of inventory imaging system 220. The GPS coordinates may be the current latitude, longitude, and altitude of inventory imaging system 220. In some embodiments, GPS module 252 is any typical GPS receiver.

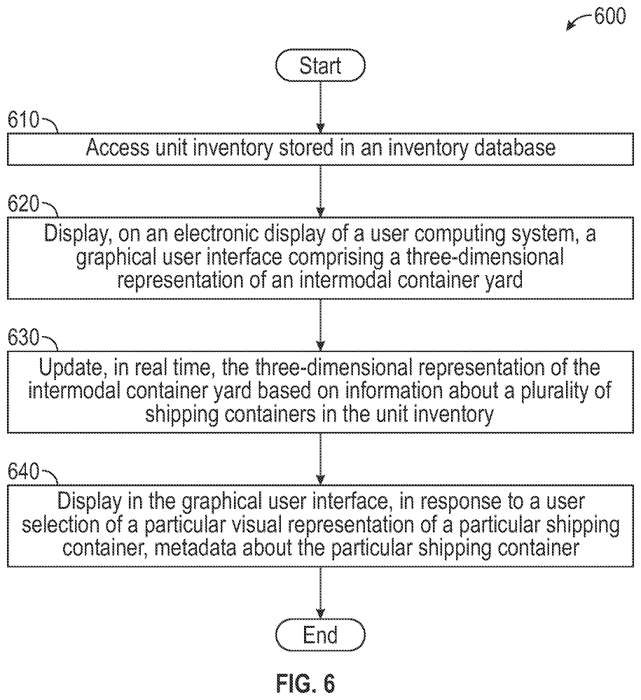

Communications interface 258 may be any hardware, software, or combination of hardware and software that provides one or more wireless interfaces (e.g., WI-FI, cellular, Bluetooth, etc.) between inventory imaging system 220 and network 230. In some embodiments, communications interface 258 provides a WI-FI interface over LTE (or any other cellular communications standard). In some embodiments, communications interface 258 may be communication interface 610 that is discussed in more detail below with respect to FIG. 6.

In some embodiments, inventory imaging system 220 may additionally include one or more illumination devices (not illustrated) that are configured to illuminate shipping containers 110 as imaging vehicle 120 moves within container yard 100. For example, inventory imaging system 220 may include one or more LED lights attached to imaging vehicle 120 and pointed towards shipping containers 110. As anther example, inventory imaging system 220 may include one or more infrared lights attached to imaging vehicle 120 and pointed towards shipping containers 110.

As discussed above, inventory imaging system 220 are systems and devices configured to capture and analyze images of container yard 100 in order to identify shipping containers 110 and their locations within container yard 100. In some embodiments, inventory imaging system 220 is coupled to an imaging vehicle 120 that moves within container yard 100. In other embodiments, however, inventory imaging system 220 may be attached to other objects within container yard 100. For example, inventory imaging system 220 may be attached to a stationary object that is in close proximity to an entrance/exit of container yard 100 in order to analyze shipping containers 110 as they enter/exit container yard 100. As another example, inventory imaging system 220 may be attached to a crane that loads/unloads shipping container 110 from a train. In general, inventory imaging system 220 may be located on any mobile or stationary object in order to capture and analyze images of container yard 100 in order to identify shipping containers 110 and their locations within container yard 100.

Network 230 allows communication between and amongst the various components of intermodal inventory management system 200. This disclosure contemplates network 230 being any suitable network operable to facilitate communication between the components of intermodal inventory management system 200. Network 230 may include any interconnecting system capable of transmitting audio, video, signals, data, messages, or any combination of the preceding. Network 230 may include all or a portion of a local area network (LAN), a wide area network (WAN), an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, etc.), a Long Term Evolution (LTE) network, a Universal Mobile Telecommunications System (UMTS) network, a peer-to-peer (P2P) network, a Bluetooth network, a Near Field Communication network, a Zigbee network, and/or any other suitable network.

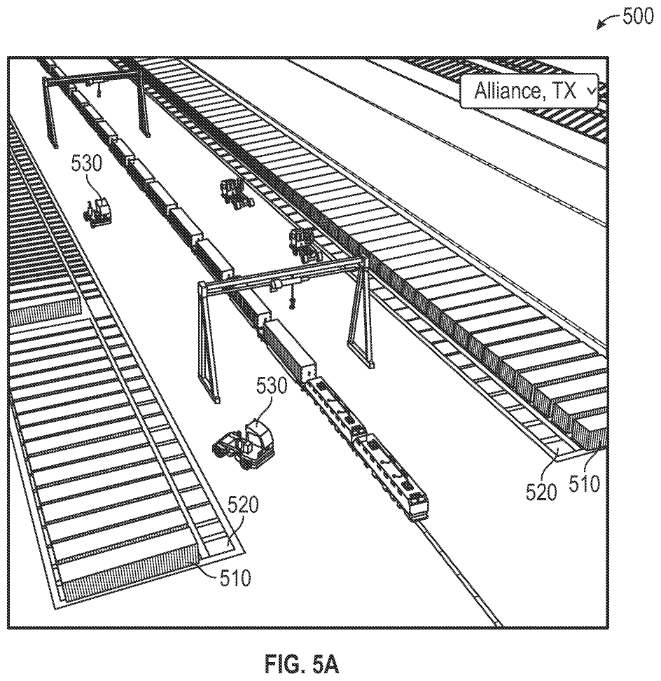

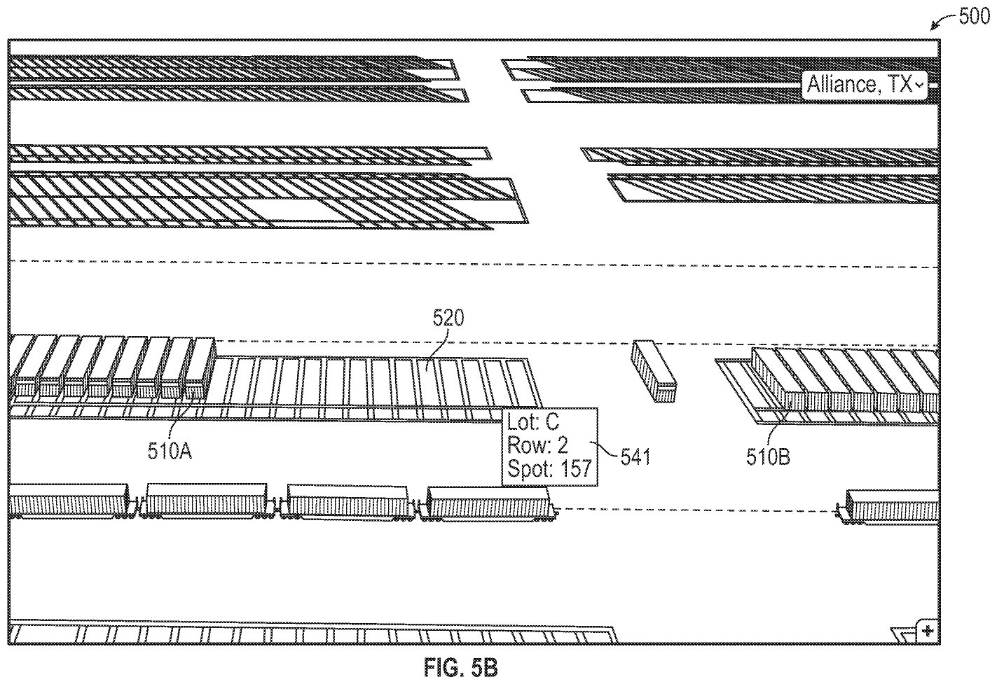

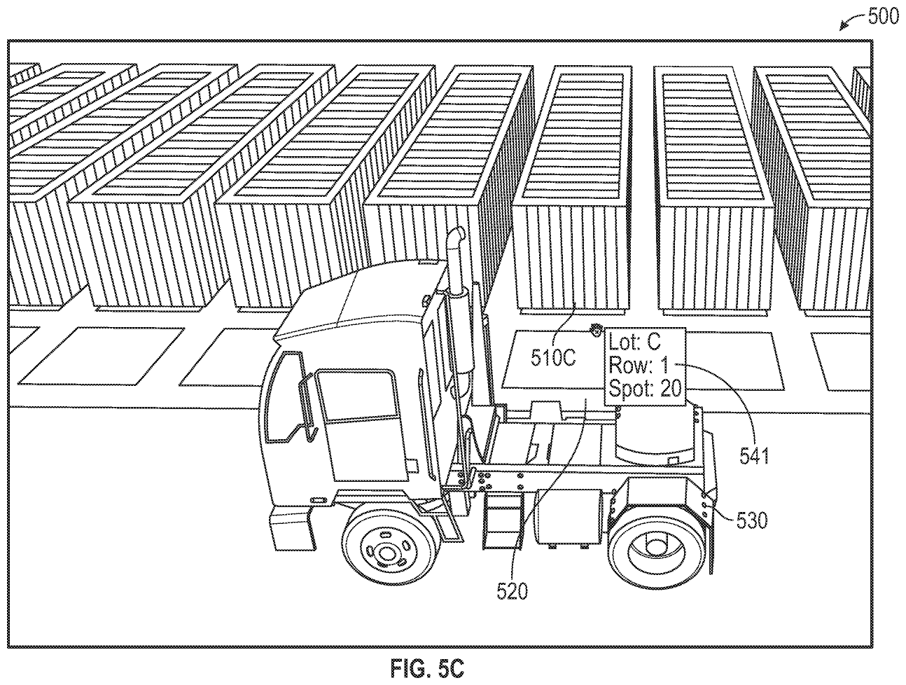

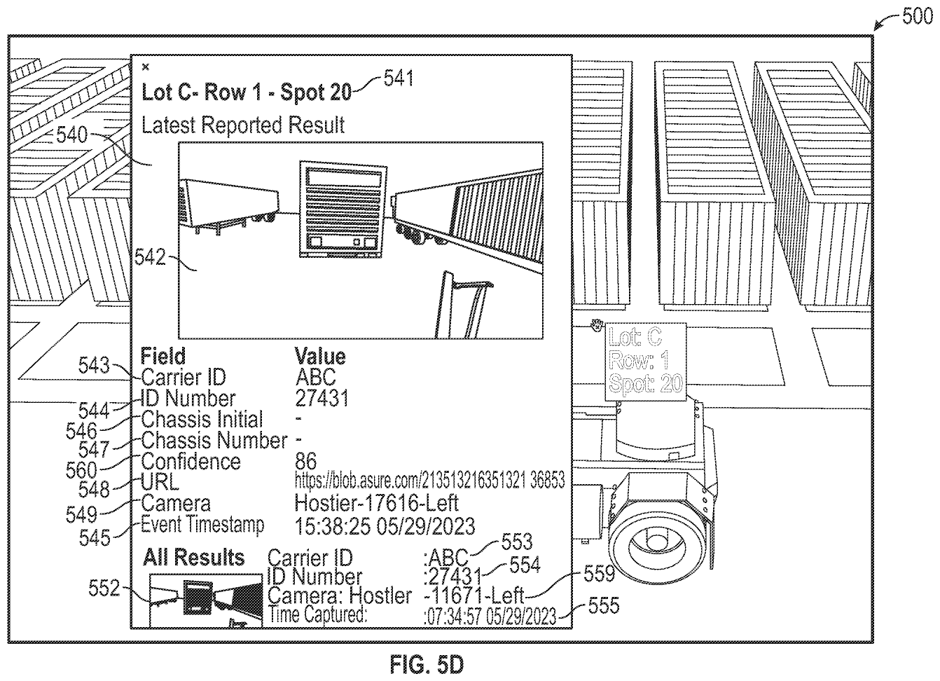

User computing system 240 can be any appropriate system or device that allows a user to interact with intermodal inventory management system 200. User computing system 240 may be a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In some embodiments, user computing system 240 includes an electronic display 242 such as computer or smartphone screen. In some embodiments, user computing system 240 may be configured to provide an interface (e.g., GUI 244) that can be structured to facilitate an operator interacting with intermodal inventory management system 200, e.g., via network 230, to execute and leverage the features provided by intermodal inventory management system 200. In some embodiments, GUI 244 may be utilized to display a real-time, three-dimensional representation of shipping containers 110 and container yard 100, as discussed below in reference to FIGS. 5C-5D.

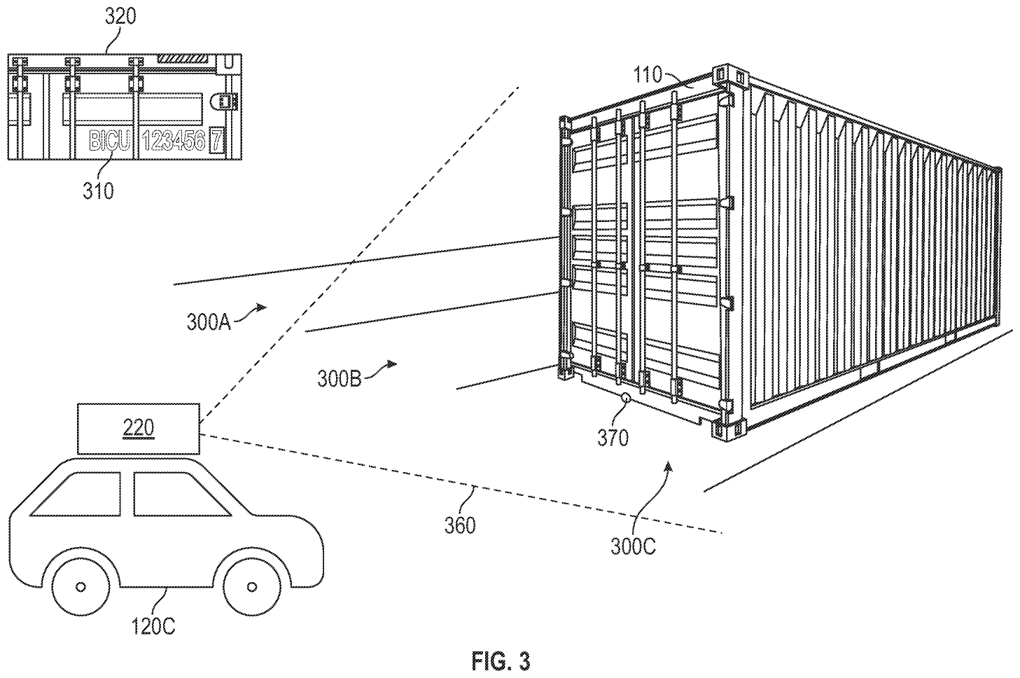

In operation, intermodal inventory management system 200 utilizes one or more inventory imaging systems 220 to capture and analyze images 217 as the one or more imaging vehicles 120 move within container yard 100 in order to determine parking locations of shipping containers 110. To do so, inventory imaging system 220 may first capture images 217 using imaging device 251 as imaging vehicle 120 moves around container yard 100. After capturing images 217, inventory imaging system 220 analyzes images 217 using machine learning module 212 in order to determine in real-time (or near-real time) that a shipping container 110 is depicted in at least one of images 217. Inventory imaging system 220 may then determine, using map 213 of the container yard 100, a parking location of the shipping container 110 identified in images 217. More details about how certain embodiments determine the parking location of a shipping container 110 are discussed below in reference to FIG. 3.

In response to determining that the shipping container 110 is depicted within at least one image 217, inventory imaging system 220 may electronically communicate to remote computing system 210 (e.g., across network 230 using communications interface 258) a message 125 about the identified shipping container 110. The message 125 sent to remote computing system 210 may include data such as the determined parking location of the identified shipping container 110 and one or more identification markings of the identified shipping container 110. More details about how certain embodiments determine the identification markings of a shipping container 110 are discussed below in reference to FIG. 3. Once message 125 is received by remote computing system 210, message processing module 211 updates unit inventory 216 using the data within message 125.

In order to conserve network bandwidth, battery power, and computer processing/memory resources, some embodiments of inventory imaging system 220 send messages 125 only when objects of interest are discovered in captured images 217. For example, some embodiments only send messages 125 in response to machine learning module 212 identifying shipping containers 110 within images 217 (i.e., a message 125 is sent by inventory imaging system 220 after each new shipping container 110 is identified within images 217, but otherwise inventory imaging system 220 does not use communications interface 258 in order to conserve resources).

By performing object detection in machine learning module 212 directly within imaging device 251 instead of a back-end server system such as remote computing system 210, embodiments of this disclosure offer significant advantages over other systems. Since inventory imaging system 220 may utilize machine learning module 212 and imaging device 251 to detect shipping containers 110 in real-time as imaging vehicle 120 traverses container yard 100, unit inventory 216 may be updated more quickly and efficiently. As a result, operators may have a more accurate understanding of the inventory within container yard 100.

In some embodiments, inventory imaging system 220 may additionally conserve resources by utilizing GPS module 252 to determine whether inventory imaging system 220 is currently located within a geofence 104 of container yard 100 (as illustrated in FIG. 1). In these embodiments, inventory imaging system 220 may prevent machine learning module 212 from analyzing images 217 when inventory imaging system 220 is currently located outside geofence 104 of container yard 100. To determine whether inventory imaging system 220 is currently located inside or outside geofence 104 of container yard 100, some embodiments compare the current GPS coordinates of inventory imaging system 220 from GPS module 252 to GPS coordinates of geofence 104. For example, geofence 104 may be in the shape of a square or rectangle and may include GPS coordinates of the four corners of geofence 104. If inventory imaging system 220 determines that the current GPS coordinates of inventory imaging system 220 are within the GPS coordinates of the four corners of geofence 104, inventory imaging system 220 determines that inventory imaging system 220 is currently located inside geofence 104 and thus proceeds to enable machine learning module 212 to analyze images 217 in order to identify shipping containers 110. On the other hand, if inventory imaging system 220 determines that the current GPS coordinates of inventory imaging system 220 are not within the GPS coordinates of the four corners of geofence 104, inventory imaging system 220 determines that inventory imaging system 220 is currently located outside geofence 104 and thus proceeds to disable and prevent machine learning module 212 from analyzing images 217 in order to conserve resources.

FIG. 3 is a diagram illustrating inventory imaging system 220 determining a parking location 300 (e.g., 300A-300C) of a shipping container 110. In general, once machine learning module 212 detects shipping container 110 within one or more images 217 captured by imaging device 251, inventory imaging system 220 then attempts to determine the exact parking location 300 of the detected shipping container 110. To do so, some embodiments first determine a current field of view 360 of imaging device 251 of inventory imaging system 220. Inventory imaging system 220 may determine the current field of view 360 of imaging device 251 by analyzing the current GPS coordinates of the system from GPS module 252. For example, if the current GPS coordinates of the system are (N, W, m) and imaging device 251 has a fixed field of view 260 of 120 degrees facing 90 degrees from the direction of travel of imaging vehicle 120, inventory imaging system 220 may determine the current field of view 360 of imaging device 251 as being 120 degrees located at (N, W, m) and facing 90 degrees from the direction of travel of imaging vehicle 120.

Once inventory imaging system 220 determines current field of view 360 of imaging device 251, inventory imaging system 220 may next determine possible parking locations 300 that are within the current field of view 360 of imaging device 251. In some embodiments, inventory imaging system 220 compares the determined current field of view 360 of imaging device 251 to stored map 213 of container yard 100 in order to determine possible parking locations 300 of the detected shipping container 110. Using the above example, inventory imaging system 220 may overlay the current field of view 360 of 120 degrees located at (N, W, m) and facing 90 degrees from the direction of travel of imaging vehicle 120 onto map 213 and determine that parking locations 300A-300C are within the current field of view 360 of imaging device 251 (as illustrated in FIG. 3).

Once inventory imaging system 220 determines the possible parking locations 300 that are within the current field of view 360 of imaging device 251, inventory imaging system 220 may determine GPS coordinates of each of the possible parking locations. In some embodiments, inventory imaging system 220 may do so by accessing map 213 and determining the GPS coordinates stored in map 213 for each of the possible parking locations. For example, each parking location in map 213 may be a rectangular region that includes GPS coordinates of each of the four corners of the rectangular region.

Next, inventory imaging system 220 may calculate GPS coordinates 370 of the detected shipping container 110 using one or more settings of imaging device 251 and the current GPS coordinates of inventory imaging system 220. In this step, inventory imaging system 220 may first determine the current GPS coordinates of inventory imaging system 220 from GPS module 252. Inventory imaging system 220 may then utilize imaging device 251 to determine a distance from inventory imaging system 220 to shipping container 110. For example, inventory imaging system 220 may in some embodiments utilize one or more settings of the imaging device (e.g., a focal length of imaging device 251 and a resolution of imaging device 251) to determine a distance from inventory imaging system 220 to shipping container 110. In other embodiments, imaging device 251 may include one or more depth sensors within imaging device 251 to determine a distance from inventory imaging system 220 to shipping container 110. Finally, inventory imaging system 220 may calculate GPS coordinates 370 of the detected shipping container 110 by adjusting the current GPS coordinates of inventory imaging system 220 with the determined distance from inventory imaging system 220 to shipping container 110.

After inventory imaging system 220 determines GPS coordinates 370 of the detected shipping container 110, inventory imaging system 220 may then determine the probable parking location 300 of shipping container 110 by comparing the GPS coordinates of each of the possible parking locations with the GPS coordinates of the shipping container. For example, if inventory imaging system 220 determines that the GPS coordinates 370 of the detected shipping container 110 are within the GPS coordinates of the four corners of parking location 300C as illustrated in FIG. 3, inventory imaging system 220 determines that the detected shipping container 110 is currently located in parking location 300C.

In some embodiments, inventory imaging system 220 may determine the probable parking location 300 of shipping container 110 across multiple images 217 and then choose which parking location 300 was determined the most times. For example, consider a scenario where imaging vehicle 120 is moving through container yard 100 and captures ten images 217 where a particular shipping container 110 is detected by machine learning module 212. From the steps discussed above, inventory imaging system 220 determines that the particular shipping container 110 is located in parking location 300A two times, is located in parking location 300B one time, and is located in parking location 300C seven times. In this scenario, inventory imaging system 220 may ultimately decide that the particular shipping container 110 is located in parking location 300C since parking location 300C was chosen the most times out of the ten images.

In some embodiments, inventory imaging system 220 may utilize any appropriate method or algorithm for determining unit identification numbers of shipping containers 110 to include in message 125. For example, FIG. 3 illustrates inventory imaging system 220 determining a unit identification 310 from an image 320. In this example, inventory imaging system 220 captures image 320 of shipping container 110 and then utilizes optical character recognition (OCR) or a machine learning algorithm to analyze image 320 and determine that unit identification 310 of shipping container 110 is “BICU 123456.” In other embodiments, inventory imaging system 220 may utilize any other appropriate technique or technology to determine unit identifications 310 (e.g., radio frequency identification (RFID), Bluetooth, WI-FI, etc.).

The functional blocks, and components thereof, of intermodal inventory management system 200 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

Various components of intermodal inventory management system 200 may illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

Further, the functionalities described with reference to each of the different functional blocks of intermodal inventory management system 200 described herein are provided for purposes of illustration, rather than by way of limitation and that functionalities described as being provided by different functional blocks may be combined into a single component or may be provided via computing resources disposed in a cloud-based environment accessible over a network, such as one of network 230.

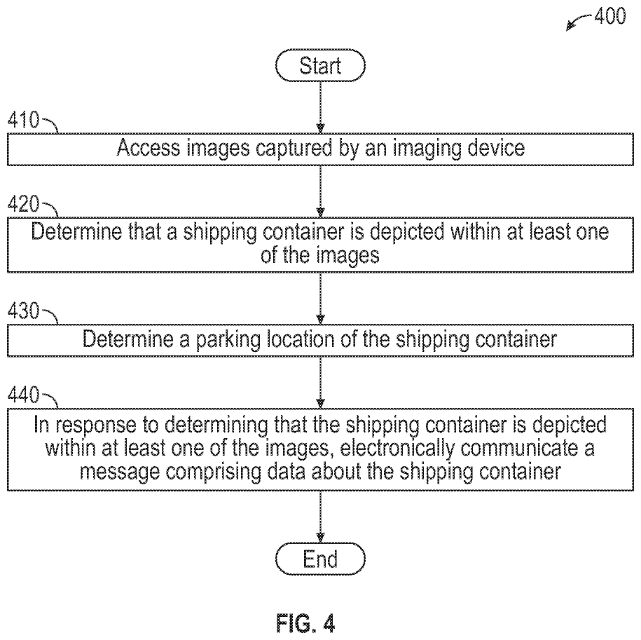

FIG. 4 is a flow diagram illustrating an example method 400 for managing intermodal inventory, according to certain embodiments. In some embodiments, the functions illustrated in the example blocks shown in FIG. 4 may be performed by inventory imaging system 220 according to embodiments herein. In some embodiments, the operations of method 400 may be stored as instructions that, when executed by one or more processors, cause the one or more processors to perform the operations of method 400.

Method 400 may be performed by a computing system and may begin in step 410. In step 410, method 400 accesses a plurality of images captured by an imaging device. In some embodiments the plurality of images are images 217 and the imaging device is imaging device 251. In some embodiments, the imaging device and the computing system are coupled to a vehicle such as imaging vehicle 120 that moves within an intermodal container yard. The vehicle may be a container delivery vehicle, an aerial vehicle, an automobile, a truck, a golf cart, an ATV, an autonomous vehicle, a motorcycle, or a remote-control vehicle.

In step 420, method 400 determines, by analyzing the plurality of images using a machine-learning module, that a shipping container is depicted within at least one of the plurality of images. In some embodiments, the machine-learning module is machine learning module 212 that is located within imaging device 251. In some embodiments, step 420 is performed only if the computing system is physically located within a geofence of the intermodal container yard.

In step 430, method 400 determines a parking location of the shipping container. In some embodiments, method 400 uses a map of the intermodal container yard in step 430 to determine the parking location of the shipping container. In some embodiments, the map is map 213. In some embodiments, the parking location is parking location 300.

In some embodiments, step 430 includes determining a current field of view of the imaging device by analyzing the current GPS coordinates of the system. The current GPS coordinates may be obtained from a GPS receiver such as GPS module 252. Step 430 may further include determining, using the determined current field of view of the imaging device and the stored map of the intermodal container yard, a plurality of possible parking locations of the intermodal container yard that are within the field of view of the imaging device. Step 430 may further include determining, from the stored map of the intermodal container yard, GPS coordinates of each of the possible parking locations that are within the field of view of the imaging device. Step 430 may further include calculating GPS coordinates of the shipping container using one or more settings of the imaging device and the current GPS coordinate of the system. The one or more settings of the imaging device may include a focal length of the imaging device and a resolution of the imaging device. Step 430 may further include determining the parking location of the shipping container by comparing the GPS coordinates of each of the possible parking locations with the GPS coordinates of the shipping container.

In step 440, method 400, in response to determining that the shipping container is depicted within at least one of the plurality of images, electronically communicates, across a communications network, a message comprising data about the shipping container. In some embodiments, the message is message 125. In some embodiments, the data about the shipping container includes the determined parking location of the shipping container and one or more identification markings of the shipping container. After step 440, method 400 may end.

FIGS. 5A-5D illustrate various views of a virtual container yard 500 that may be displayed in GUI 244 on user computing system 240, according to certain embodiments. In general, virtual container yard 500 is a three-dimensional representation of container yard 100 that permits a user to view the real time (or near real-time) status (e.g., inventory and location of vehicles such as imaging vehicle 120) of container yard 100. For example, a user may utilize user computing system 240 such as a smartphone or computer to view virtual container yard 500 in GUI 244 on electronic display 242. The user may manipulate (e.g., move, rotate, zoom in, zoom out, etc.) virtual container yard 500 in order to view the current status of shipping containers 110 and vehicles such as imaging vehicle 120 within container yard 100, as described in more detail below.

In some embodiments, a computer system such as remote computing system 210 may continuously update virtual container yard 500 using information from intermodal inventory management system 200 that is stored in unit inventory 216 in inventory database 214, as described above. For example, remote computing system 210 may access unit inventory 216 at predetermined intervals (e.g., every second, minute, hour, etc.) and update virtual container yard 500 accordingly. In other embodiments, remote computing system 210 may access unit inventory 216 when a change is detected in unit inventory 216 and then update virtual container yard 500 accordingly. In still other embodiments, remote computing system 210 may access unit inventory 216 after a message 125 is received from inventory management system 200 and then update virtual container yard 500 accordingly. As a result, virtual container yard 500 may be updated in real time (or near real time) in order to provide an accurate depiction of the current status of container yard 100.

In some embodiments, virtual container yard 500 is a three-dimensional model of container yard 100. In some embodiments, virtual container yard 500 is generated using a map of container yard 100 such as map 213. In general, virtual container yard 500 may be generated using any appropriate computer-based three-dimensional modeling software or application.

As illustrated in FIGS. 5A-5C, certain embodiments of virtual container yard 500 include visual representations 510 of shipping containers 110, virtual parking locations 520, and visual representations 530 of vehicles (e.g., imaging vehicle 120 or a hostler). Visual representations 510 of shipping containers 110 are generally three-dimensional models of shipping containers 110 that are placed at virtual parking locations 520 that correspond to physical parking locations (e.g., parking locations 300) of the corresponding shipping containers 110 in container yard 100 as determined by inventory imaging system 220. In some embodiments, the appearance of visual representations 510 of shipping containers 110 are based on carrier identifications of shipping containers 110 (e.g., current carrier identification 543). For example, all shipping containers 110 that are identified as belonging to carrier “ABC” may have a visual representation 510A that has a first appearance that matches a typical shipping container of carrier “ABC,” and all shipping containers 110 that are identified as belonging to carrier “XYZ” may have a visual representation 510B that has a second appearance that matches a typical shipping container of carrier “XYX,” as illustrated in FIG. 5B. In other embodiments, different colors, shapes, shading, etc. may be used on visual representations 510 to distinguish shipping containers 110 that are identified as belonging to carrier “ABC” from shipping containers 110 that are identified as belonging to carrier “XYZ.”

In some embodiments, virtual container yard 500 includes visual representations 530 of vehicles such as imaging vehicle 120 or a hostler. Visual representations 530 are generally three-dimensional models of vehicles that are placed within virtual container yard 500 at locations that correspond to physical locations of the actual vehicles within container yard 100. In some embodiments, visual representation 530 of vehicles are placed within virtual container yard 500 using GPS coordinates from the vehicle (e.g., from GPS module 252). In some embodiments, the appearance of each visual representation 530 is based on the type of represented vehicle. For example, as illustrated in FIGS. 5A and 5C, visual representation 530 may appear as a hostler when the represented vehicle is a hostler.

In some embodiments, virtual container yard 500 may display an indication 541 for each virtual parking location 520. For example, as illustrated in FIG. 5C, some embodiments may display indication 541 when a user selects or otherwise interacts with (e.g., hovers a pointer over) virtual parking location 520. In some embodiments, indication 541 may include a lot identification (e.g., “Lot: C”), a row identification (e.g., “Row: 1”), and a spot identification (e.g., “Spot: 20”) of virtual parking location 520, as illustrated in FIG. 5C.

As illustrated in FIG. 5D, some embodiments of virtual container yard 500 include metadata 540 about shipping container 110. For example, metadata 540 about shipping container 110 may be displayed in response to a user selection of a particular visual representation 510 of shipping container 110 or a virtual parking location 520. In some embodiments, metadata 540 about shipping container 110 includes indication 541 of parking location 300 (e.g., “Lot C—Row 1—Spot 20”) and a current image 542 of parking location 300. Current image 542 of parking location 300 may be captured, for example, by imaging device 251 as imaging vehicle 120 moves around container yard 100, as described above. In general, current image 542 of parking location 300 is the latest (i.e., most recent) image available for the selected parking location.

In some embodiments, metadata 540 about shipping container 110 includes a current carrier identification 543 (e.g., carrier/owner of “ABC”) and a current identification number 544 (e.g., “27431”) of shipping container 110 located in the selected parking location. In general, current carrier identification 543 and current identification number 544 are physical markings on shipping container 110 that provide a unique identification for shipping container 110. In some embodiments, current carrier identification 543 and current identification number 544 are determined by inventory imaging system 220, as described above in reference to FIG. 3 (e.g., using OCR or a machine learning algorithm to analyze images 320).

In some embodiments, metadata 540 about shipping container 110 includes a timestamp 545, a chassis initial 546, a chassis number 547, a URL 548, and a camera ID 549. Timestamp 545 can indicate a time that current image 542 of parking location 300 was captured. The chassis initial 546 can include one or more characters related to a chassis, chassis number 547 can include one or more characters related to a chassis, and URL 548 can provide a hyperlink to media associated with the chassis or container. Camera ID 549 can be an identification of the camera (e.g., imaging device 251) used to capture current image 542 of parking location 300.

In some embodiments, metadata 540 about shipping container 110 includes a history of information captured about the selected parking location. For example, as illustrated in FIG. 5D, metadata 540 about shipping container 110 may include a previous image 552 of parking location 300, a previous carrier identification 553, a previous identification number 554 of shipping container 110, a timestamp 555 of previous image 552, and a camera ID 549 of the camera used to capture previous image 552. While metadata 540 about shipping container 110 illustrates a single previous image 552 and associated data, other embodiments may include more than one previous image 552 and their associated data.

In some embodiments, metadata 540 about shipping container 110 includes a confidence value 560 that is associated with the current carrier identification 543 and the current identification number 544 of the selected shipping container. In general, confidence value 560 may be provided by inventory imaging system 220 and may indicate how reliable the current carrier identification 543 and the current identification number 544 of the selected shipping container may be. In some scenarios, it may be difficult to distinguish with absolute certainty the characters of unit identification 310, as discussed in reference to FIG. 3. This may be due to, for example, low quality images 320 (e.g., due to weather or a dirty camera lens) or the presence of characters that are notorious for being difficult to determine using OCR (e.g., “3” vs. “8”, “8” vs. “B”, etc.). To account for this uncertainty, inventory imaging system 220 may, in some embodiments, calculate a confidence level 560 using any appropriate technique and then send the confidence level 560 for display in metadata 540 about shipping container 110. In some embodiments, confidence level 560 may be expressed as a value between 0-100.

FIG. 6 is a flow diagram illustrating an example method 600 for visualizing intermodal inventory, according to certain embodiments. In some embodiments, the functions illustrated in the example blocks shown in FIG. 6 may be performed by one or both of inventory imaging system 220 and remote computing system 210, according to embodiments herein. In some embodiments, the operations of method 600 may be stored as instructions that, when executed by one or more processors, cause the one or more processors to perform the operations of method 600.

Method 600 may be performed by a computing system and may begin in step 610. In step 610, method 600 accesses a unit inventory stored in an inventory database. The unit inventory includes information about a plurality of shipping containers physically located in an intermodal container yard. In some embodiments, the unit inventory is unit inventory 216 and the inventory database is inventory database 214. In some embodiments, the computing system is remote computing system 210. In some embodiments, the shipping containers are shipping containers 110 and the intermodal container yard is container yard 100.

At step 620, method 600 provides one or more instructions to display, on an electronic display of a user computing system, a graphical user interface that includes a three-dimensional representation of the intermodal container yard. In some embodiments, the electronic display is electronic display 242 and the user computing system is user computing system 240. In some embodiments, the graphical user interface is GUI 244 and the three-dimensional representation of the intermodal container yard is virtual container yard 500.

At step 630, method 600 updates the three-dimensional representation of the intermodal container yard based on the information about the plurality of shipping containers in the unit inventory. In some embodiments, method 600 updates the three-dimensional representation of the intermodal container yard in step 630 in real time or near real time. In some embodiments, method 600 updates the three-dimensional representation of the intermodal container yard in step 630 at predetermined intervals (e.g., every second, minute, hour, etc.). In other embodiments, method 600 updates the three-dimensional representation of the intermodal container yard in step 630 when a change is detected in unit inventory 216. In still other embodiments, method 600 updates the three-dimensional representation of the intermodal container yard in step 630 after a message 125 is received from inventory imaging system 220. In some embodiments, step 630 includes providing, in the three-dimensional representation of the intermodal container yard, a visual representation (e.g., visual representation 510) of each shipping container physically located in the intermodal container yard, wherein the visual representation of each particular shipping container is placed at a virtual parking location (e.g., virtual parking location 520) in the three-dimensional representation of the intermodal container yard that corresponds to a physical parking location (e.g., parking location 300) of the particular shipping container in the intermodal container yard. In some embodiments, step 630 includes providing, in the three-dimensional representation of the intermodal container yard, a visual representation (e.g., visual representation 530) of a current location of a vehicle travelling within the intermodal container yard.

At step 640, method 600 provides one or more instructions to display in the graphical user interface, in response to a user selection of a particular visual representation of a particular shipping container, metadata about the particular shipping container. In some embodiments, the metadata is metadata 540 about shipping container 110. In some embodiments, the metadata includes one or more of: an indication of a particular physical parking location of the particular shipping container (e.g., indication 541 of parking location 300); a current image of the particular physical parking location (e.g., current image 542); a current carrier identification of the particular shipping container (e.g., current carrier identification 543); a current identification number of the particular shipping container (e.g., current identification number 544); and a timestamp of the current image (e.g., timestamp 545). In some embodiments, the metadata includes one or more of: a previous image of the particular physical parking location (e.g., previous image 552); a previous carrier identification of the particular shipping container (e.g., previous carrier identification 553); a previous identification number of the particular shipping container (e.g., previous identification number 554); and a timestamp of the previous image (e.g., timestamp 555). After step 640, method 600 may end.

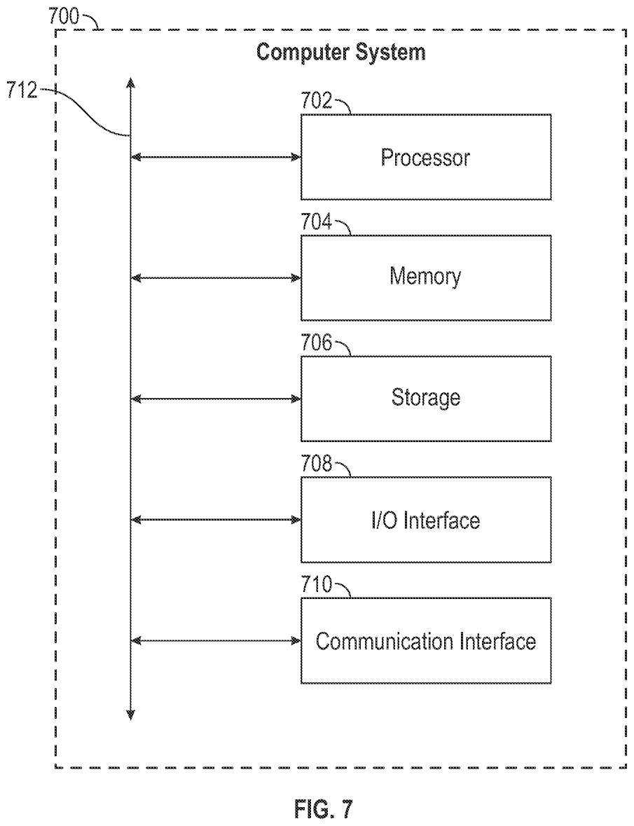

FIG. 7 illustrates an example computer system 700 that may be utilized as remote computing system 210 and inventory imaging computing system 250. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example, and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example, and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example, and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example, and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 can be non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example, and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). For example, the terms “processor” and “controller” can be a class of structures, rather than one specific structure, and may be defined with functional terms, but that does not make it means-plus-function. Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules disclosed herein may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium can be coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. The terms Disk and disc can include compact disc (CD), laser disc, optical disc, digital versatile disc (DVD), floppy disk, and Blu-ray disc where disks usually reproduce data magnetically, while discs usually reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function, in substantially the same way, or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for visualizing inventory of an intermodal container yard, the system comprising:
an inventory database storing a unit inventory, the unit inventory comprising information about a plurality of shipping containers physically located in the intermodal container yard;
one or more memory units; and
one or more computer processors communicatively coupled to the inventory database and the one or more memory units and configured to:
access the unit inventory stored in the inventory database;
provide one or more instructions to display, on an electronic display of a user computing system, a graphical user interface comprising a three-dimensional representation of the intermodal container yard;
update, in real time, the three-dimensional representation of the intermodal container yard based on the information about the plurality of shipping containers in the unit inventory, wherein updating the three-dimensional representation of the intermodal container yard comprises:
providing, in the three-dimensional representation of the intermodal container yard, a visual representation of each shipping container physically located in the intermodal container yard, wherein the visual representation of each particular shipping container is placed at a virtual parking location in the three-dimensional representation of the intermodal container yard that corresponds to a physical parking location of the particular shipping container in the intermodal container yard; and
providing, in the three-dimensional representation of the intermodal container yard, a visual representation of a current location of a vehicle travelling within the intermodal container yard; and
provide one or more instructions to display in the graphical user interface, in response to a user selection of a particular visual representation of a particular shipping container, metadata about the particular shipping container.

2. The system for visualizing inventory of the intermodal container yard of claim 1, wherein the metadata about the particular shipping container comprises one or more of:
an indication of a particular physical parking location of the particular shipping container;
a current image of the particular physical parking location;
a current carrier identification of the particular shipping container;
a current identification number of the particular shipping container;
a timestamp of the current image.

3. The system for visualizing inventory of the intermodal container yard of claim 2, wherein the metadata about the particular shipping container further comprises one or more of:
a previous image of the particular physical parking location;
a previous carrier identification of the particular shipping container;
a previous identification number of the particular shipping container; and
a timestamp of the previous image.

4. The system for visualizing inventory of the intermodal container yard of claim 2, wherein the indication of the particular physical parking location of the particular shipping container comprises:
a lot identification;
a row identification; and
a spot identification.

5. The system for visualizing inventory of the intermodal container yard of claim 2, wherein the metadata about the particular shipping container further comprises a confidence value associated with the current carrier identification of the particular shipping container and the current identification number of the particular shipping container.

6. The system for visualizing inventory of the intermodal container yard of claim 1, wherein the visual representation of each shipping container physically located in the intermodal container yard is based on a carrier identification of the particular shipping container.

7. The system for visualizing inventory of the intermodal container yard of claim 1, wherein the vehicle comprises:
a container delivery vehicle;
an aerial vehicle;
an automobile;
a truck;
a golf cart;
an all-terrain vehicle (ATV);
an autonomous vehicle;
a motorcycle; or
a remote-control vehicle.

8. A method, by a computing system, for visualizing inventory of an intermodal container yard, the method comprising:
accessing a unit inventory stored in an inventory database, the unit inventory comprising information about a plurality of shipping containers physically located in the intermodal container yard;
providing one or more instructions to display, on an electronic display of a user computing system, a graphical user interface comprising a three-dimensional representation of the intermodal container yard;
updating the three-dimensional representation of the intermodal container yard based on the information about the plurality of shipping containers in the unit inventory, wherein updating the three-dimensional representation of the intermodal container yard comprises:
providing, in the three-dimensional representation of the intermodal container yard, a visual representation of each shipping container physically located in the intermodal container yard, wherein the visual representation of each particular shipping container is placed at a virtual parking location in the three-dimensional representation of the intermodal container yard that corresponds to a physical parking location of the particular shipping container in the intermodal container yard; and
providing, in the three-dimensional representation of the intermodal container yard, a visual representation of a current location of a vehicle travelling within the intermodal container yard; and
providing one or more instructions to display in the graphical user interface, in response to a user selection of a particular visual representation of a particular shipping container, metadata about the particular shipping container.

9. The method for visualizing inventory of the intermodal container yard of claim 8, wherein the metadata about the particular shipping container comprises one or more of:
an indication of a particular physical parking location of the particular shipping container;
a current image of the particular physical parking location;
a current carrier identification of the particular shipping container;
a current identification number of the particular shipping container;
a timestamp of the current image.

10. The method for visualizing inventory of the intermodal container yard of claim 9, wherein the metadata about the particular shipping container further comprises one or more of:
a previous image of the particular physical parking location;
a previous carrier identification of the particular shipping container;
a previous identification number of the particular shipping container; and
a timestamp of the previous image.

11. The method for visualizing inventory of the intermodal container yard of claim 9, wherein the indication of the particular physical parking location of the particular shipping container comprises:
a lot identification;
a row identification; and
a spot identification.

12. The method for visualizing inventory of the intermodal container yard of claim 9, wherein the metadata about the particular shipping container further comprises a confidence value associated with the current carrier identification of the particular shipping container and the current identification number of the particular shipping container.

13. The method for visualizing inventory of the intermodal container yard of claim 8, wherein the visual representation of each shipping container physically located in the intermodal container yard is based on a carrier identification of the particular shipping container.

14. The method for visualizing inventory of the intermodal container yard of claim 8, wherein the vehicle comprises:
a container delivery vehicle;
an aerial vehicle;
an automobile;
a truck;
a golf cart;
an all-terrain vehicle (ATV);
an autonomous vehicle;
a motorcycle; or
a remote-control vehicle.

15. One or more computer-readable non-transitory storage media embodying instructions that, when executed by a processor, cause the processor to perform operations comprising:
accessing a unit inventory stored in an inventory database, the unit inventory comprising information about a plurality of shipping containers physically located in an intermodal container yard;
providing one or more instructions to display, on an electronic display of a user computing system, a graphical user interface comprising a three-dimensional representation of the intermodal container yard;
updating the three-dimensional representation of the intermodal container yard based on the information about the plurality of shipping containers in the unit inventory, wherein updating the three-dimensional representation of the intermodal container yard comprises:
providing, in the three-dimensional representation of the intermodal container yard, a visual representation of each shipping container physically located in the intermodal container yard, wherein the visual representation of each particular shipping container is placed at a virtual parking location in the three-dimensional representation of the intermodal container yard that corresponds to a physical parking location of the particular shipping container in the intermodal container yard; and
providing, in the three-dimensional representation of the intermodal container yard, a visual representation of a current location of a vehicle travelling within the intermodal container yard; and
providing one or more instructions to display in the graphical user interface, in response to a user selection of a particular visual representation of a particular shipping container, metadata about the particular shipping container.

16. The one or more computer-readable non-transitory storage media of claim 15, wherein the metadata about the particular shipping container comprises one or more of:
an indication of a particular physical parking location of the particular shipping container;
a current image of the particular physical parking location;
a current carrier identification of the particular shipping container;
a current identification number of the particular shipping container;
a timestamp of the current image.

17. The one or more computer-readable non-transitory storage media of claim 16, wherein the metadata about the particular shipping container further comprises one or more of:
a previous image of the particular physical parking location;
a previous carrier identification of the particular shipping container;
a previous identification number of the particular shipping container; and
a timestamp of the previous image.

18. The one or more computer-readable non-transitory storage media of claim 16, wherein the indication of the particular physical parking location of the particular shipping container comprises:
a lot identification;
a row identification; and
a spot identification.

19. The one or more computer-readable non-transitory storage media of claim 16, wherein the metadata about the particular shipping container further comprises a confidence value associated with the current carrier identification of the particular shipping container and the current identification number of the particular shipping container.

20. The one or more computer-readable non-transitory storage media of claim 15, wherein the visual representation of each shipping container physically located in the intermodal container yard is based on a carrier identification of the particular shipping container.
